(19) United States
(12) Patent Application Publication
(10) Pub. No.: US 2014/0053756 A1
(43) Pub. Date: Feb. 27, 2014

(54) METHOD FOR PRODUCING CELLULOSE-CONTAINING MASS FOR PRODUCING COMPOSITE MATERIAL

(71) Applicant: Vadim Gogichev, Develier (CH)

(72) Inventor: Vadim Gogichev, Develier (CH)

(21) Appl. No.: 14/007,961

(22) PCT Filed: Mar. 29, 2012
(86) PCT No.: PCT/EP12/55662

§ 371 Date: Nov. 12, 2013

(30) Foreign Application Priority Data
Apr. 1, 2011 (CH) 00601/11

(51) Int. Cl. D21C 5/00; B29C 45/00; B29C 43/00

(52) U.S. Cl. CPC D21C 5/00; B29C 43/003; B29C 45/0005
USPC 106/204.01; 106/163.01; 264/330; 264/319

(57) ABSTRACT

The invention relates to a method for producing a cellulose-containing mass for forming a cellulose-containing composite material comprising following steps: (a) providing an input material comprising at least one cellulose-containing raw material and a liquid content; (b) macerating the cellulose-containing raw material in the input material; and (c) homogenizing the input material to obtain the cellulose-containing mass for forming cellulose-containing composite material by using an apparatus selected from a homogenizer, a refiner and a wet-milling apparatus. According to a further embodiment of the present invention cellulose of different types is added to the input. Moreover a method for producing a composite material that is based on said cellulose-containing mass is disclosed as well as a product produced of said composite material.

### TECHNICAL FIELD

The invention relates to a method for producing a cellulose-containing mass for forming a cellulose-containing composite material according to claim 1, a cellulose-containing mass according to claim 16, a method for producing a cellulose-containing composite material according to claim 17, a cellulose-containing composite material according to claim 20, and a product according to claim 21.

The method may be employed for a diversity of practical uses. For instance, production of new building materials, different hardware, trimmings, interior stuff, various finishing coats of high resistibility and fastness etc.

### PRIOR ART

Currently there are several composite materials of organic origin known which are for example suitable for packaging and construction applications. While wood fibers are quite common other natural fibers from crop or grain are used occasionally as fibrous fillers.

US 2006043629 A proposes to produce a reinforced bio-composite by processing of natural fibers (such as grass, rice straw, wheat straw, industrial hemp, pineapple leaf fibers) with a matrix of soy based bioplastic, by employing a coupling agent, i.e. a functional monomer modified polymer. Moreover the use of modified soy flour with functional monomers is explained in the context of industrial applications such as reactive extrusion and injection molding.

US 2008/181969 A addresses discoloration and structural, that is chemical or mechanical, degradation of composite materials comprising cellulosic components such as wood fibers, straw, grasses and other organic material that is cross linked by means of coupling agents to polymer components. The coupling agents, such as grafted-maleic anhydride polymers or copolymers, incorporate functionality capable of forming covalent bonds within or between the polymer and cellulosic components.

### SUMMARY OF THE INVENTION

It is an object of the present invention to provide an improved method of production of cellulose-containing masses, to provide said cellulose-containing masses and to provide methods for producing high-strength composite materials comprising original structures of organic materials, preferably originating from higher plants, which evolve their natural forms (e.g. stalks) through intracellular and intercellular structural linkage between different polymers and/or their moieties of different substances, functional groups, side chains and/or rests.

The invention relates to a method for producing a cellulose-containing mass for the production of high-strength composite materials and various items made of cheap cellulose-containing raw materials.

The method for comprises following steps, some of which are optional:
a. Providing an input material comprising at least one cellulose-containing raw material and a liquid content;
b. maceration of the cellulose-containing raw material in the in the input material;
c. homogenization of the input material to obtain a pulpy cellulose-containing mass;
d. removing excess liquid content; and
e. mixing the cellulose-containing mass optionally with additional cellulose.

Optionally stones or other solid non-organic material can be removed from the cellulose-containing raw material or the input material before homogenization. The cellulose-containing mass can then be further used to produce a cellulose-containing composite material.

The idea of the method lies in the fact that during manufacturing natural forms of inputs are destructed, as well as their organic linkages of intracellular and intercellular structures do, until homogenous liquid and/or paste mass is produced. Such a cellulose-containing mass is used further as molding sand: it is reshaped with new geometrical form, and structural linkages are recovered while this paste is curing. Cured paste becomes the end-use item. The invention allows to produce composite materials without requiring the use of exogenous polymeric components for bonding the raw materials, for example the plant particles to each other. In the context of the present application, the term exogenous denotes that the polymeric component origins not from the cellulose-containing raw material being processed.

Hereinafter, the term input material is used to refer to the starting substance or mixture of substances that is exposed to the maceration and homogenization procedure, whereas the term cellulose-containing mass denotes the product produced by the aforementioned method according to the invention. Said product is considered to be an intermediate product (also called output) as it is used further for the production of a wide variety of products denoted as cellulose-containing composite material.

In first step an input material is provided comprising a cellulose-containing raw material and a liquid content. Advantageously, the raw material origins from higher plants, preferably from the group of true grasses of the family Gramineae (Poaceae) such as cereal crop, or from cotton, hemp or flax or a mixture thereof. The cellulose-containing raw material can be derived from farm waste of cereals (e.g. maize, rye, wheat, oats, barley, sorghum, rape, rice etc. and combinations thereof), staple fibers (e.g. cotton, flax, hemp, etc.), what makes such production economically compatible due to low price of the input. The cellulose-containing raw material is preferably made of stalk parts of higher plants, cell envelopes or membrane that contain sufficient quantity of cellulose, i.e. a high-molecular polysaccharide or glucan composed of β-1,4-linked D-glucose. Cellulose—the most common organic compound on Earth—is a high molecular polysaccharide with formula [C₆H₇O₂(OH)₃], structured into polymer chains of β-glucose units, where n ranges from hundreds to some thousands. Good results have been produced in tests using at least one of cereal straw or rice straw or mixtures thereof as the raw material.

Depending on the desired properties of the cellulose-containing mass and/or the pre-processing preparation, the endogenous liquid content, i.e. the liquid content provided by the raw material itself or originating from the raw material, is sufficient so that no exogenous or additional liquid has to be added. In its simplest embodiment, the liquid content is formed by water. However, other liquids, like organic solvents or gases or other fluids may is be suitable as liquid contents depending on the demands on the manufacturability and on the characteristics of the article to be formed of the composite material later on. However, it is important that a proper function of the liquid content with the raw material is achievable. In case of liquids other than water it is essential to preferred embodiments of the invention that an excess of the liquid content is extractable in a suitable manner after the cellulose-containing mass is produced, where necessary. Depending on the intended use and the intended processing method, the liquid content comprises preferably a solvent, e.g. for mellowing the raw material.

The cellulose-containing raw material of the input material can be pre-processed or pre-treated depending on the type and conditions of the raw material. Such conditions are particle size, moisture, cleanness, presence of irrelevant natural or artificial elements, the microbial population, and the percentage of β-cellulose in the pure raw material responsible for generating bundles of micelles in the form of superfine fibrils. Preliminary determination of organic base content between fibrils and cellulose agglutinating these fibrils into the solidest fibers proved to be advantageous. As a rule, organic materials containing agglutinating or gelling substances like pectin are suitable, but organic materials containing substances like suberins or cutin that are by nature more hydrophobic are suitable as well. Alternatively organic materials containing lignin may also be used.

Preferably, the raw material can be reduced to small particles of an average size of about 0.1 to 3 cm, preferably 0.5-2 cm, by cutting, shredding or the like in a pre-processing step.

Cellulose fibers have a noted distinction of high resistance against laceration, barely coming short of steel, and resistance against variance of mechanical and physical exposures. In case that the organic material is straw, e.g. rice or wheat or rye straw, a liquid having a pH-value of about 8 or above, more preferably about 8.4 or above may be used for maceration purposes followed and/or accompanied by electromechanical exposure, hydrodynamic exposure, ultrasonic exposure, boiling, steaming or a combination thereof.

It is known from the prior art, for example from WO 08/112,191 that in lignocellulosic biomass, crystalline cellulose fibrils are embedded in a less well-organized hemicellulose matrix which, in turn, is surrounded by an outer lignin seal. Contacting naturally occurring cellulosic materials with hydrolyzing enzymes generally results in cellulose hydrolysis yields that are less than 20% of theoretically predicted results. Hence, some “pretreatment” of the biomass is invariably carried out prior to attempting the enzymatic hydrolysis of the polysaccharides (cellulose and hemicellulose) in the biomass. Pretreatment refers to a process that converts lignocellulosic biomass from its native form, in which it is recalcitrant to cellulase enzyme systems, into a form for which cellulose hydrolysis is effective. Compared to untreated biomass, effectively pretreated lignocellulosic materials are characterized by an increased surface area (porosity) accessible to cellulase enzymes, and solubilization or redistribution of lignin. Increased porosity results mainly from a combination of disruption of cellulose crystallinity, hemicellulose disruption/solubilization, and lignin redistribution and/or solubilization. The relative effectiveness in accomplishing some (or all) of these factors differs greatly among different existing pretreatment processes. These include dilute acid, steam explosion, hydrothermal processes, “organosols” processes involving organic solvents in an aqueous medium, ammonia fiber explosion (AFEX), strong alkali processes using a base such as, ammonia, NaOH or lime, and highly-concentrated phosphoric acid treatment. Those methods known from the art as mentioned above and further known methods for treatment of cellulose containing biomaterials may advantageously be combined with the method steps according to the present invention.

In a preferred embodiment one kilogram of cellulose-containing raw material is mixed with 1-20 liters, preferably 7-15 liters, of a master solution to obtain the input material. The master solution can be e.g. 0.1 N H₂SO₄, H₂O, or 1N NaOH. The input material can then be cooked for about 3 hours. When using NaOH as master solution the NaOH based mixture can be neutralized after cooking.

Additionally, stones or other solid non-organic material can be removed from the raw material or the input material in a separate optional step. This step can be performed before or after the addition of the master solution (liquid content) and has the advantage the machines for further processing are not damaged or quickly worn off by e.g. stones.

In the following steps the cellulose-containing raw material in the input material is macerated and the input material is then homogenized to obtain a pulpy cellulose-containing mass. Thus, maceration and homogenization can be performed in separate steps. Maceration and homogenization can also be performed during the same step e.g. by wet-milling. During maceration the cellulose-containing raw material becomes softened mainly as a result of being wetted or steeped. Partial hydrolysis of the cellulose may occur. During homogenization the cellulose-containing raw material is further broken down and defibrated. Thereby the particle size of the cellulose-containing raw material is reduced to an average particle size of about 1-2 mm. Maceration and/or homogenization can be performed at elevated temperatures and/or high pressure, both having the advantage of killing certain bacteria and fungi. The elevated temperature can be in the range of 70 to 120° C., preferably 80 to 100° C., and most preferred at about 92 to 94° C.

The homogenization can be achieved by mechanical cutting, crushing, breaking and/or grinding the input material until a more homogenous cellulose-containing mass is produced. The homogenization step can be performed e.g. with a homogenizer or a refiner. Examples for a homogenizer are the INDAG Homogenizer type DLM/H from INDAG Maschinenbau GmbH, Germany or the YTRON-Z Homogenizer from YTRON Process Technology GmbH & Co., Germany. An example for a refiner is the conical refiner INDAG Refiner type DLM/R from INDAG Maschinenbau GmbH, Germany. Using a homogenizer or a refiner it is advantageous to soften the cellulose-containing raw material by the maceration step beforehand.

According to a further embodiment the homogenization is performed by a wet-milling procedure with high-speed cutting mills with high frequency cutting strokes for the fine grinding of the cellulose-containing raw material, for example straw of cereals. In the case of the wet-milling procedure the maceration and the homogenization take place at the same time. Maceration and homogenization can be further optimized by performing the wet-milling procedure at elevated temperatures. The elevated temperature can be in the range of 70 to 120° C., preferably 80 to 100° C., and most preferred at about 92 to 94° C.

In a preferred embodiment excess liquid content of the cellulose-containing mass obtained from the homogenization procedure can be removed, e.g. by sedimentation, filtration, extrusion or pressing out, to obtain a cellulose-containing mass with about 20 to 40% dry weight.

According to preferred embodiments, additional cellulose preferably methyl cellulose and/or carboxy methyl cellulose, preferably in the form of a sodium salt, and/or microcrystalline cellulose can be added to the cellulose-containing mass. The carboxy methyl cellulose (CMC) can be e.g. from Fischer Chemicals Chemicals AG, Riesbachstrasse 57, CH-8034 Zurich, Switzerland with the CAS Number 9004-32-4. According to a further preferred embodiment of the present invention, the additional cellulose can be at least partially added as concentrated cellulose containing fraction generated in the homogenization procedure. The cellulose containing liquid fraction separated during or after homogenizing can be concentrated by filtration or dehydration until the fraction reaches a desired level of cellulose content in relation to the water content. If additional cellulose and what kind of additional cellulose is added depends on the product for which the cellulose-containing mass will be used. The addition of additional cellulose leads to stronger composite materials.

After the homogenization step, the intermediate product can—according to further preferred embodiments—be mixed with additional cellulose, for example in a high-performance Ringlayer Mixer CoriMix® CM available from Gebr. Lödige Maschinenbau GmbH, Elsener Straβe 7-9, 33102 Paderborn, Germany. Such mixers are actually not only mixing but also further homogenizing and comminuting. Their preferred performance is based on the high peripheral speed of the mixing mechanism of up to 40 m/s. The resultant centrifugal force forms a concentric annular layer of the input comprising the least one organic material and the hot liquid content. The profile of the annular layer features a high mixing intensity, which is caused by the high differential speed between the rotating specially shaped mixing tools and the mixer wall. The product is moved through the mixing chamber in a plug-like flow, with the residence time being influenced by the degree of filling, the number of revolutions, the geometry and adjustment of the mixing tools as well as the mixing vessel length and the volume flow rate. The mixing chamber may be divided into zones of different shear intensity, and preferably the mixer is combined with a turbulent mixer also known from and available from Lödige Maschinenbau GmbH.

It has been shown in a series of experiments that it is advantageous to add cellulose in the form of microcrystalline cellulose (MCC), a highly crystalline particulate cellulose consisting primarily of crystallite aggregates obtained by removing amorphous (fibrous cellulose) regions of a purified cellulose source material by hydrolytic degradation, to the cellulose containing mass. 5 to 10 weight percent, preferably 7 weight percent of MCC, preferably with a mean size range of about 15 to 40 microns, were added to each batch in each experiment. The addition of microcrystalline cellulose, especially when added to inputs containing primarily cereal straw, resulted in cellulose-containing mass which were preferably used for producing composite materials of high strength. Said composite materials produced form microcrystalline cellulose containing masses have increased hardness and tensile strength when compared to similar composites produced without the addition of microcrystalline cellulose. The mixing procedure leads to a homogenous paste-like cellulose-containing mass and can also be performed without adding additional cellulose.

After termination of the mixing the cellulose-containing mass is ready to be used for producing a composite material and for producing a desired product of said cellulose-containing mass.

The cellulose-containing mass forms the base material for a vast range of composite products with a wide range of shapes, forms and designs. Said composites may be produced by direct shaping methods like casting, moulding, pressing or extruding or by subsequently machining the aforementioned.

The technology and technique of producing composite products from the cellulose-containing mass in accordance with preferred embodiments of the invention include at least the following basic steps:
a. Preliminary preparation of the cellulose-containing mass, comprising additives/improvers where necessary, including the previously described additional techniques of manufacturing;
b. post-processing by at least one of curing and molding of the cellulose-containing mass until a product (end-use item) is produced.

The term product encompasses end-products, such as for example panels, as well as semi-products, e.g. a core material of a laminated construction such as a sandwich construction, for example. In case of the latter, certain properties of the product may be improved for example in that at least one liner is adhesively bonded to said semi-product. An advantage of such sandwich constructions is that different properties such as structural strength, lightweight construction, fire resistance or a combination thereof are conferrable to a product. Depending on the embodiment of the product, one or several layers or liners may be made of metal, glass or carbon fibers or meshing.

Such non-organic fibers may be even added to the input material or added later on to the is cellulose-containing masses according to the invention.

Alternatively and/or in addition thereto, the cured composite material maybe subject to suitable surface treatment that is discussed later on in this description.

The process of drying and/or curing denotes an extracting of excessive liquid from the cellulose-containing mass. Processes of structural linkage recovery appear while the cellulose-containing mass is shaped, for example by curing in casts or molds. Such processes are actually an integration of remains of β-glucose n-molecules into molecular compound with common to polymers formula [C₆H₇O₂(OH)₃]ₙ. The presence of glucose molecules with three hydroxyl groups [(OH) groups] in each rest allow that linkage between said rests is facilitated through lateral hydroxyl groups by abstraction of water molecules from them. Therefore, structural linkage recovery of the organic material in the cellulose-containing mass takes place as soon as excessive liquid of the cellulose-containing mass is extracted, for example by desiccation or drying in case of water, resulting in a curing process.

In case of water being used as the liquid content the dehydration process is carried out under a predetermined temperature by any of a range of known suitable techniques. Such techniques are comprising and/or combining compression, extrusion and filtration as well as absorption, vacuum drying, blow-drying, heating, radiation, patting, vaporization under blower and other methods of desiccation, including natural air drying for example. Selection of a specific method of dehydration depends upon the specific requirements on the process and/or the article to be molded. In a preferred embodiment the product is dried at a temperature between 80 to 90° C., until the final product has less than 20% humidity, preferably less than 14%. The drying can last 16 to 24 hours.

Depending on the characteristics of the cellulose-containing mass and/or the requirements on the composite material or the product to be produced thereof, the post-processing of the cellulose-containing mass is performed by at least one of molding, compression molding, injection molding. However, other shaping techniques for producing the product may be suitable.

In case of a post-processing by compression molding it is conceivable that the mixing container or a part thereof form a half of the mold at the same time. As general molding techniques are known to the person skilled in the art there a detailed description thereof is omitted. Moulding under pressure can be performed at 120-220° C.

Depending on the demands and the manufacturability, the molding and curing operation are carried out together or in sequence.

Further post-processing may be performed, e.g. for improving the resistance of the article made of the composite material against moisture or water, or to enhance its durability against chemically aggressive environments, the microbiological resistance, to confer the composite material and/or the product with required characteristics in view of a special type of resistance, a specific color, a particular smell or a combination thereof. For this purpose, specific modifiers and/or additives may be added into the input and/or the cellulose-containing mass prior to the extraction of any excessive liquid content.

Depending on the requirements, said specific modifiers and/or additives may be employed for achieving a particular homogeneity of the cellulose-containing mass and/or the composite material.

Special attention shall be paid to the fact, that several types of plant cells are encrusted by or containing compounds like inorganic minerals, for example silicates, or organic minerals like oxalates. The directed selection of cellulose-containing raw materials containing certain amounts of said compounds like for example minerals can be used to provide cellulose-containing masses and composite materials according to the invention providing certain properties demanded by end-users. For instance, by selecting raw materials with employing the ability that the mentioned materials can acquire or significantly improve such characteristics and properties as conductance, transcalency (i.e. the thermal conductivity), sound-proofness, resistance against moisture deformation, chemical and microbiological exposure and so on. In addition exogenous modifiers may be added if the cellulose-containing mass does not satisfy the requirements on the composite material.

Production of materials with predetermined properties (resistance, hydropathy, durability against chemically aggressive milieu, microbiological resistance, additional and/or special type of resistance, color, smell etc.) including those required by consumer's priorities is achieved by adding specific modifiers into homogeneous mass before dehydration and/or using special supplemental techniques while preparing homogeneous mass for curing.

Now, a few possibilities for surface treatment shall be addressed in brief. Depending on the requirements on the product made of the composite material, certain characteristics are achievable e.g. by applying one or several coatings with an impregnation, e.g. by way of immersion. Moreover, a coating layer with a specific color is applicable likewise.

All declarations in the description above apply likewise for the cellulose-containing mass, the method for producing the composite material, the composite material itself as well as for the produced thereof.

### BRIEF EXPLANATION OF THE FIGURES

The invention is described in greater detail below with reference to embodiments that are illustrated in the figures. The figures show:

FIG. 1 flow charts of the method according to the invention under (a) with separate maceration and homogenization steps and under (b) with combined maceration and homogenization steps.

### EMBODIMENTS OF THE INVENTION

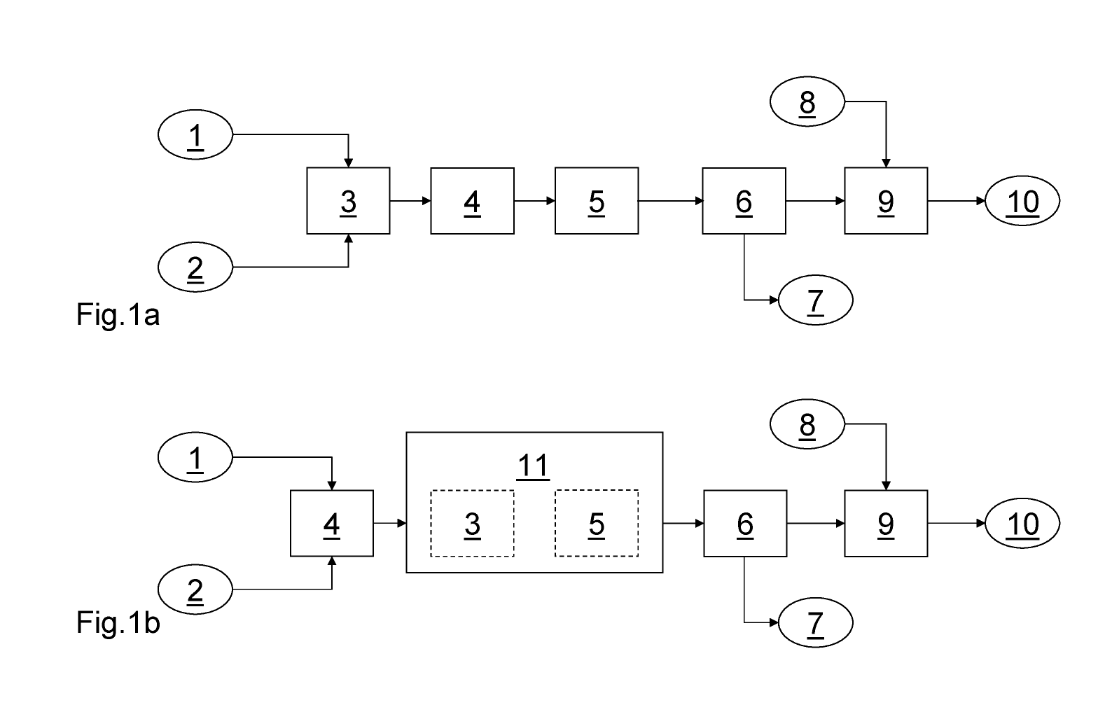

FIG. 1 shows two flow charts of the method according to the invention. In the method as depicted in FIG. 1a the maceration and homogenization are performed in two separate steps with different machines. Cellulose-containing raw material 1 with an average particle size of about 0.1 to 3 cm, preferably about 0.5 to 2 cm, and a master solution 2 are combined with each other to form the input material. On one kilogram of cellulose-containing raw material 1-20 litres, preferably 7-15 litres, of the master solution are used. The master solution is preferably one of 0.1 N H₂SO₄, H₂O, or 1N NaOH. The input material is then submitted to a maceration step 3, in which the cellulose-containing mass in the input material is softened by the master solution 2. During the maceration step 3 partial hydrolysation of the cellulose (cellulose and hemicellulose) may take place. In an optional cleaning step 4 stones and other solid non-organic material can be removed from the input material. In the method depicted in FIG. 1a the cleaning step 4 is performed after the maceration step 3. However, the cleaning step 3 can also be performed before the maceration step 3. The removal of stones can be important to prevent damaging the equipment (e.g. homogenizer, refiner, etc.) used for the further steps and to reduce its wearing down. During a homogenization step 5 the input material is homogenized and the cellulose-containing raw material in the input material is further broken down and defibrated. Thereby the particle size of the cellulose-containing raw material is reduced to an average particle size of about 1-2 mm. The homogenization can be performed with a homogeniser (e.g. from YTRON Process Technology GmbH & Co., Germany or Indag Maschinenbau GmbH, Germany) or a refiner such as a conical refiner (e.g. from Indag Maschinenbau GmbH, Germany).

After the homogenization step 5 a pulpy cellulose-containing mass is obtain from which excess liquid 7 is removed in a liquid removing step 6 e.g. by sedimentation, filtration, extrusion or pressing out, to obtain a cellulose-containing mass with about 20 to 40% dry weight. The excess liquid can contain cellulose, which can be concentrated separately and can be used as additional cellulose 8 in a mixing step 9.

In the mixing step 9 a homogenous paste-like cellulose-containing mass 10 is obtain, which can then be used to form the desired composite materials. Depending on the use of the cellulose-containing mass additional cellulose 8 can be added during the mixing step 9. The additional cellulose 9 can be methyl cellulose, carboxy methyl cellulose, preferably in the form of a sodium salt, microcrystalline cellulose, concentrated cellulose from the excess liquid 7 as described above or combinations thereof.

The method as depicted in FIG. 1b differs from the method in FIG. 1a in that the maceration step 3 and the homogenization step 5 are performed during a wet-milling step 10 with high-speed cutting mills and high frequency cutting strokes for the fine grinding of the cellulose-containing raw material, for example straw of cereals. During wet-milling cellulose is released from the cellulose-containing raw material and hydrolysis of the cellulose can take place. The hydrolysis can be further optimized by performing the wet-milling procedure at elevated temperatures. The elevated temperature can be in the range of 70 to 120° C., preferably 80 to 100° C., and most preferred at about 92 to 94° C.

The wet-milling step 9 can be performed with a fine cutting mill of the CONDUX CS 500 or CS 1000Z type, available from Netzsch-Condux Mahltechnik GmbH, Rodenbacher Chausee 1, D-63457 Hanau/Wolfgang, Germany which is intended for dry milling and was adapted and used for wet-milling of the input material at elevated temperatures.

### Example 1

Wheat straw was pre-treated by chopping up the stalks of straw until the straw pieces had is an average size of about 5 to 7 millimeters. 100 kg of chopped straw were mixed with 1000 l of hot water in order to produce a trial batch of input material.

A fine cutting mill of the CONDUX CS 500 or CS 1000Z type, available from Netzsch-Condux Mahltechnik GmbH, Rodenbacher Chausee 1, D-63457 Hanau/Wolfgang, Germany which is intended for dry milling was adapted and used for wet-milling of the input at elevated temperatures.

All trial batches were wet-milled immediately after production of the batches in CONDUX Fine cutting mills CS 500, available from Netzsch-Condux. The preferred temperature range of the water straw mixture during wet milling was kept at about 92 to 94° C. The cellulose-containing mass coming out of the wet-milling process had a moisture content in excess of 90 wt % water and a particle size of approx. 1 mm. The milling product was of excellent fineness and homogeneity and already suitable for the production of a composite material and for producing a desired product of said cellulose-containing mass.

### Example 2

Wheat straw was pre-treated by chopping up the stalks of straw until the straw pieces had an average size of about 5 to 7 millimeters. 100 kg of chopped straw were mixed with 1000 l of hot water in order to produce a trial batch of input material.

A fine cutting mill of the CONDUX CS 500 or CS 1000Z type, available from Netzsch-Condux Mahltechnik GmbH, Rodenbacher Chausee 1, D-63457 Hanau/Wolfgang, Germany which is intended for dry milling was adapted and used for wet-milling of the input material at elevated temperatures.

All trial batches were again wet-milled immediately after production of the batches in the adapted CONDUX Fine cutting mills CS 500, available from Netzsch-Condux. The preferred temperature range of the water straw mixture during wet-milling was kept at about 92 to 94° C. During wet-milling, an aqueous, liquid cellulose-containing fraction was separated and drained from the mill. Said hot liquid fraction can be recycled to the mill. According to preferred embodiments however, it was further concentrated by filtering or by dehydration and added during mixing. The mixing was performed in a high-performance Ringlayer Mixer CoriMix® CM available from Gebr. Lödige Maschinenbau GmbH.

### Example 3

Several samples of cellulose-containing composite material with cellulose-containing mass have been produced. Average values for density (kg/m3), compression strength at 10% (MPa), tensile strength (kPa), flexural strength (MPa) and heat conductivity (W/mK) were measured on samples with fine or coarse particle composition.

TABLE 2
Properties of cellulose-containing composite material

| | |
|---|---|
| fine particle | coarse particle |
| composition | composition |

| | | | | |
|---|---|---|---|---|
| density | 439.7 | kg/m3 | 327.3 | kg/m3 |
| compression strength | 2070 | kPa | 3145 | kPa |

| | | | |
|---|---|---|---|
| tensile strength | — | 754 | kPa |

| | | | | |
|---|---|---|---|---|
| flexural strength | 7943 | kPa | 4618 | kPa |
| heat conductivity | | | 0.0744 | W/mK |

The above listed experiments show that according to the present invention the addition of cellulose based adhesives and binders, preferably in a water-soluble form as methyl cellulose and carboxy methyl cellulose enhances the properties of the produced masses and materials. In further preferred embodiments microcrystalline cellulose and/or powdered cellulose is added to achieve further desired properties.

### LIST OF REFERENCE NUMBERS

1 cellulose-containing raw material
2 liquid content/master solution
3 maceration
4 cleaning
5 homogenization
6 liquid removing
7 excess liquid
8 mixing
9 additional cellulose
10 cellulose-containing mass
11 wet-milling

1: A method for producing a cellulose-containing mass for forming a cellulose-containing composite material comprising the following steps:
a. providing an input material comprising at least one cellulose-containing raw material and a liquid content;
b. macerating the cellulose-containing raw material in the input material; and
c. homogenizing the input material to obtain the cellulose-containing mass for forming the cellulose-containing composite material by using an apparatus selected from a homogenizer, a refiner and a wet-milling apparatus.

2: The method according to claim 1, wherein the cellulose-containing raw material is pre-treated by reducing the particle size to an average size of about 0.5-2.0 cm.

3: The method according to claim 1, wherein stones or other solid non-organic material is removed from the cellulose-containing mass or the input material before homogenizing the input material.

4: The method according to claim 1, wherein the cellulose-containing raw material origins from higher plants.

5: The method according to claim 1, wherein the liquid content comprises at least one component selected from the group consisting of water and solvents.

6. The method according to claim 1, wherein one kilogram of cellulose-containing raw material is mixed with 1-20 liters of a master solution to obtain the input material and wherein the master solution is 0.1 N H₂SO₄, H₂O or 1 N NaOH.

7. The method according to claim 1, wherein the organic material in the input material is macerated at a pH-value of about 8.

8. The method according to claim 1, wherein the maceration and/or the homogenization is performed at a temperature in the range of 70 to 120° C.

9. The method according to claim 1, wherein excess liquid content is removed from the cellulose-containing mass to obtain a cellulose-containing mass with about 20 to 40% dry weight.

10: The method according to claim 1, wherein an aqueous, liquid cellulose-containing fraction is separated during or after the homogenization procedure.

11. The method according to claim 1, wherein additional cellulose is added to the cellulose-containing mass.

12: The method according to claim 1, wherein at least one additive or modifier is added to at least one of the input material or the cellulose-containing mass.

13: A cellulose-containing mass produced by the method of claim 1.

14: A method for producing a cellulose-containing composite material from the cellulose-containing mass of claim 13, wherein the cellulose-containing composite material is formed by at least one of molding, compression molding and injection molding.

15. A cellulose-containing composite material produced by the method according to claim 14.

16: A product produced from a composite material according to claim 15.

17: The method according to claim 2, wherein the cellulose-containing raw material is pre-treated by reducing the particle size to an average size of about 0.7-1.0 cm.

18: The method according to claim 4, wherein the cellulose-containing raw material originates from cotton, hemp, flax, cereal straw, rice straw, or mixtures thereof.

19. The method according to claim 6, wherein one kilogram of cellulose-containing raw material is mixed with 7-15 liters of the master solution.

20: The method according to claim 7, wherein the organic material in the input material is macerated at a pH-value of more than 8.

21: The method according to claim 8, wherein the maceration and/or the homogenization is performed at a temperature in the range of 80 to 100° C.

22: The method according to claim 11, wherein additional cellulose is added to the cellulose-containing mass by returning a cellulose-containing fraction separated during or after the homogenizing procedure after concentration or dehydration.
